(19) United States
(12) Patent Application Publication
(10) Pub. No.: US 2009/0111539 A1
(43) Pub. Date: Apr. 30, 2009

(54) MOBILE DEVICE

(75) Inventors: Hiroaki MATSUDA, Kawasaki (JP); Tatsuhito Araki, Kawasaki (JP); Yoshiya Matsumoto, Kawasaki (JP); Manabu Sotodate, Kawasaki (JP); Wataru Murata, Kawasaki (JP); Ken Shoji, Kawasaki (JP); Ryo Hattori, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/256,603

(22) Filed: Oct. 23, 2008

(30) Foreign Application Priority Data
Oct. 30, 2007 (JP) 2007-281994

(51) Int. Cl. H04M 1/00

(52) U.S. Cl. 455/575.3

(57) ABSTRACT

A mobile device includes a housing in which an opening is defined, a lid freely uncovering or covering the opening. The lid has a body plate that defines part of the outer shape of the mobile device. The lid has a fitting projection projecting from the opening side face of the body plate and fitting into the opening. The lid has a groove formed all the way along a periphery so that a waterproof O-ring is disposed. The O-ring prevents entry of water into the opening by being fitted in the groove so as to be in contact with an internal wall face of the opening. The projection has a plurality of pressing ribs that are separately disposed along the groove so as to project in the inward direction of the groove at least in a portion opposite the rotation shaft and so as to narrow the groove.

### CROSS-REFERENCE TO RELATED APPLICATIONS

This application is based upon and claims the benefit of priority of the prior Japanese Patent Application No. 2007-281994, filed on Oct. 30, 2007, the entire contents of which are incorporated by reference herein.

### BACKGROUND

1. Field

As aspect of the invention relates to a mobile device that includes, for example: a housing in which an opening is defined; and a lid freely uncovering or covering the opening by opening or closing one edge of the opening which serving as a rotating shaft.

2. Description of the Related Art

The use of mobile devices such as mobile phones and portable video game machines has increased greatly recently. While these mobile devices have incorporated more sophisticated functions, there is also a demand for a waterproof function.

A mobile device such as a mobile phone has an opening for connecting with, e.g., an external device. Rendering the opening securely waterproof without degrading the compact design of the device poses a problem.

In terms of an opening in which a battery is loaded, for example, Japanese Laid-open Patent Publication No. 2004-56164 discloses rendering a battery pack storage section waterproof by means of an O-ring and an inner cover. Japanese Laid-open Patent Publication No. 11-25940 discloses rendering a battery pocket waterproof by means of a battery lid and waterproof packing.

It is important to render the opening and its periphery waterproof while opening and closing action is repeated, such that waterproof performance is secured whenever the opening is covered. The size and weight of the mobile device, however, should not be increased.

Generally, such an opening is rendered waterproof by fixing packing or an O-ring to a lid covering the opening. The packing or O-ring is depressed against the edges of the opening or an internal wall of the opening. In this case, however, it is preferable for the packing or O-ring to be depressed without being subjected to a large sideways force, since the sideways force may twist the packing or O-ring. To achieve this, it is best to depress the lid which covers the opening from directly above the opening. However, depressing the lid from directly above the opening, while keeping the lid and body joined, requires a complicated structure. This frustrates the demand for a more compact design. A lid for an opening that is not waterproof generally adopts a structure in which one edge of the lid is joined to the body by means of a hinge. The lid opens or closes around the hinge. Such a structure may be preferable in view of a simplified structure or compact design. However, in this case, whenever the lid is closed, a sideways force is applied to a waterproof member, such as an O-ring, attached to the lid. Consequently, the O-ring or suchlike member may be twisted. This torsion produces force in which the lid may be lifted, leading to a degraded waterproof performance. As a result of such a force, the lid may be slightly opened, which may mar the appearance of the mobile device.

### SUMMARY

In one embodiment, a mobile device is provided that achieves a reduction in torsion of waterproof members, a secure waterproof function, and a satisfactory appearance, while having a general structure in which the body has a lid that opens and closes like a door.

According to an aspect of the embodiment, a mobile device includes a housing in which an opening is defined, a lid freely uncovering or covering the opening, a body plate defining part of the outer shape of the mobile device, a fitting projection projecting from the opening side face of the body plate and fitting into the opening, and a groove formed all the way along a periphery so that a waterproof O-ring is disposed, wherein the O-ring preventing entry of water into the opening by being fitted in the groove so as to be in contact with an internal wall face of the opening, wherein the projection has a plurality of pressing ribs that are separately disposed along the groove so as to project in the inward direction of the groove at least in a portion opposite the rotation shaft and so as to narrow the groove, thereby pressing sideways the O-ring disposed in the groove.

Additional objects and advantages of the embodiment will be set forth in part in the description which follows, and in part will be obvious from the description, or may be learned by practice of the embodiment. The object and advantages if the embodiment will be realized and attained by means of the elements and combinations particularly pointed out in the appended claims.

It is to be understood that both the foregoing general description and the following detailed description are exemplary and explanatory only and are not restrictive of the embodiment, as claimed.

The above-described embodiments of the present invention are intended as examples, and all embodiments of the present invention are not limited to including the features described above.

### BRIEF DESCRIPTION OF THE DRAWINGS

FIG. 1 is a perspective view of the appearance of a mobile phone that is an embodiment of the mobile device disclosed in a preferred embodiment;

FIG. 2 is a perspective view of a body unit, as viewed from the rear of the body unit;

FIG. 3A is an exploded perspective view of the inside of a lid to which an O-ring is not attached;

FIG. 3B is a perspective view of the O-ring;

FIG. 4 is an enlarged view of part of the inside of the lid to which the O-ring is not attached;

FIG. 5A is a top view of the lid to which the O-ring is attached;

FIG. 5B is a left side view of the lid shown in FIG. 5A;

FIG. 5C is a right side view of the lid shown in FIG. 5A;

FIG. 5D is a top view of the lid shown in FIG. 5A;

FIG. 5E is a bottom view of the lid shown in FIG. 5A;

FIG. 5F is a rear view of the lid shown in FIG. 5A; and

FIG. 6 shows the opening of a housing, and the movement of the lid closing the opening.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

The mobile device disclosed in the preferred embodiment will be described below in detail with reference to FIGures.

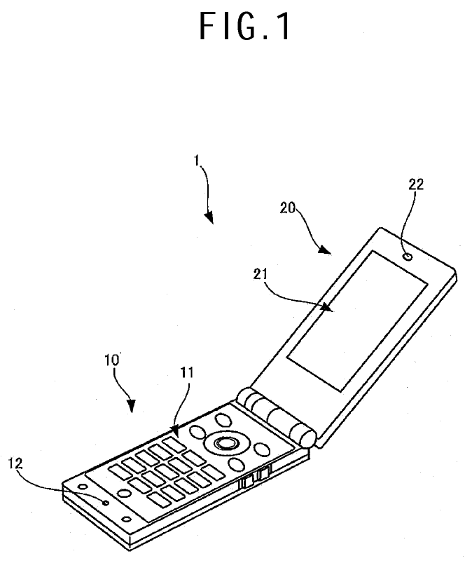

FIG. 1 is a perspective view of the appearance of a mobile phone that is an embodiment of the mobile device disclosed in the preferred embodiment.

The mobile phone 1 includes a body unit 10 and a display unit 20. The display unit 20 is pivotally supported by the body unit 10 so that it may be opened or closed.

A number of keys 11 are disposed on the body unit 10 for inputting telephone numbers or various other information by a user. A mouthpiece 12 is disposed at the lower end of the body unit 10. The mouthpiece 12 is connected to a microphone disposed inside the body unit 10.

The display unit 20 has a display screen 21 in its central area for displaying images. An earpiece 22 is above the display screen 21 for outputting sound from a sound producer disposed inside.

The mobile phone 1 incorporates electronic mail transmission or reception functions, in addition to a radio telephone function and various other functions.

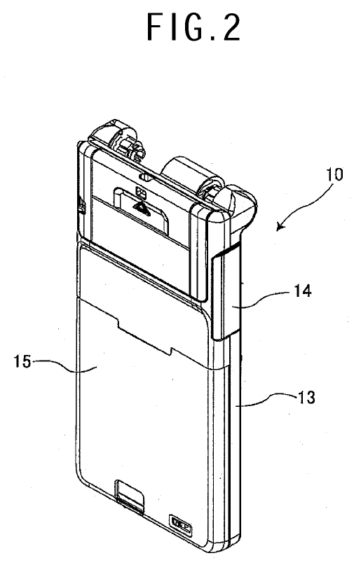

FIG. 2 is a perspective view of a body unit, as viewed from the rear of the body unit.

An opening is made in the side of the housing 13 of the body unit 10, and a lid 14 is provided for freely uncovering or covering the opening.

The body unit 10 has a rear cover 15 that freely opens and closes. Inside the rear cover 15 is a battery chamber in which a battery pack is loaded. The mobile phone 1 runs on power supplied from this battery pack which is loaded.

The mobile phone 1 has a waterproof function in which the structures of not only the insides of the lid 14 but also a rear cover 15 and the other parts of the mobile phone 1 are all watertight. A description will now be given focusing on the structure of the lid 14 that is specific to the present embodiment.

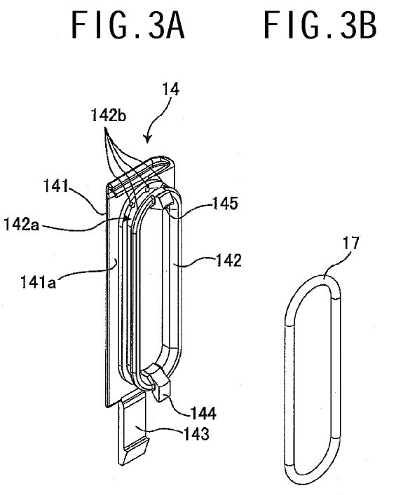

FIG. 3A is an exploded perspective view of the inside of a lid to which an O-ring is not attached and FIG. 3B is a perspective view of the O-ring.

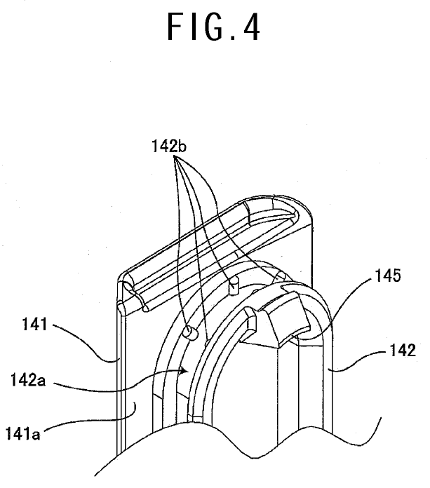

FIG. 4 is an enlarged view of part of the inside of the lid to which the O-ring is not attached.

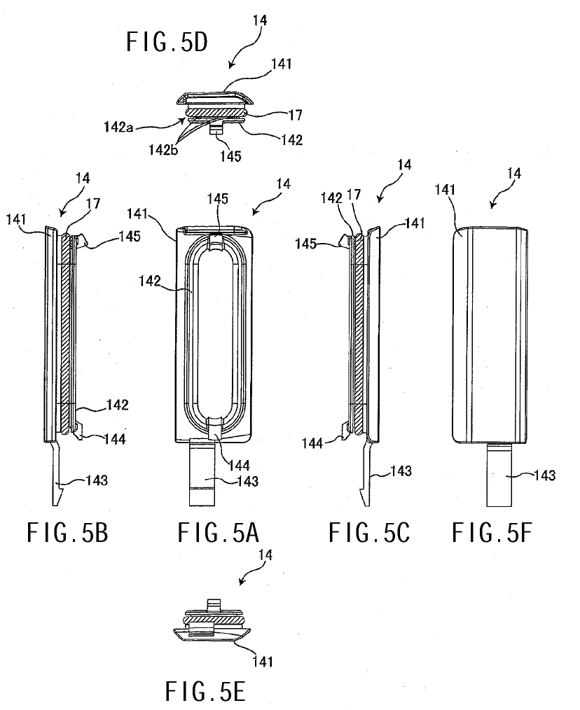

FIG. 5A is a top view of the lid to which the O-ring is attached, FIG. 5B is a left side view of the lid shown in FIG. 5A, FIG. 5C is a right side view of the lid shown in FIG. 5A, FIG. 5D is a top view of the lid shown in FIG. 5A, FIG. 5E is a bottom view of the lid shown in FIG. 5A and FIG. 5F is a rear view of the lid shown in FIG. 5A.

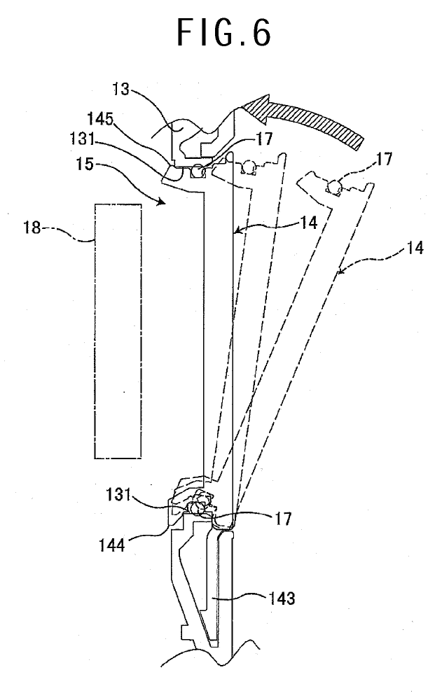

FIG. 6 shows the opening of a housing, and the movement of the lid closing the opening.

The lid 14 opens and closes around one edge of the opening 15 in the housing 13, and freely uncovers or covers the opening 15. The lid 14 has a body plate 141 and a fitting projection 142.

The body plate 141 defines part of the outer shape of the mobile phone 1.

The fitting projection 142 projects from the side face 141a of the opening 15 of the body plate 141, and fits into the opening 15 made in the housing 13. A groove 142a is formed in the sides of the fitting projection 142. An O-ring is disposed along the periphery of the fitting projection. The O-ring 17 is fitted in the groove 142a. As shown in FIG. 6, the O-ring is disposed in contact with the wall face 131 of the housing 13 all the way along. The O-ring prevents entry of water through the opening 15. The opening 15 is a vertical oval shape. The fitting projection 142 is also a vertical oval-shaped in order to match the opening 15.

A plurality of pressing ribs 142b is formed in the upper part (see FIG. 3) of the groove 142a. The pressing ribs 142b project in the inward direction of the groove 142a and narrow the width of the groove 142a. The plurality of pressing ribs 142b is disposed such that a plurality of pairs (e.g., three) of pressing ribs 142b is disposed separately along the groove 142a. The pairs of pressing ribs 142b project toward each other from opposite walls defining the groove 142a

These pressing ribs 142b press sideways the O-ring 17 disposed in the groove 142a. The pressing ribs 142b prevent the O-ring 17 from being twisted by a sideways force applied to the O-ring 17 during opening or closing of the lid 14.

The lower side of the body plate 141 of the lid 14 has a flap 143. The flap 143 presents the lid 14 from falling from the housing 13 when the lid 14 is open while held in the housing 13. A projection 144 is formed at the lower end of the fitting projection 142 of the lid 14 for use as a rotation shaft. A locking projection 145 is formed at the upper end of the fitting projection 142, that is, opposite the rotation shaft projection 144 on the long axis of the oval shape of the fitting projection 142. The pressing ribs 142 are located on the locking projection 145 side, projecting inwards in the groove 141a.

As shown in FIG. 6, the rotation shaft projection 144 enters the opening 15 of the housing 13, and is locked by the housing 13 so as to be freely rotated. The rotation shaft projection 144 serves as a rotation shaft parallel to the short axis of the oval shape of the fitting projection 142.

As shown in FIG. 6, the locking projection 145 enters the opening 15 of the housing 13 and is locked by the housing 13, thereby keeping the lid 14 in the closed position.

As shown in FIG. 6, the opening 15 is closed with the lid 14. The lid 14 is rotated in the direction of the arrow shown in FIG. 6 while the rotation shaft projection 144 is locked on the edge of the opening 15 of the housing 13. The locking projection 145 is locked on the opposite edge of the opening 15 while the rotation shaft projection 144 is locked on the edge of the opening 15 of the housing 13. At this moment, a portion of the O-ring 17 on the locking projection 145 side where the movement of the lid 14 is large slides against the internal wall of the housing 13 defining the opening. As a result, the force in the direction in which the O-ring 17 is twisted acts on the O-ring 17. However, as described above, the pressing ribs 142b are disposed separately on this portion. The pressing ribs 142b prevent torsion of the O-ring. The O-ring 17 is deformed in contact with the internal wall defining the opening 15. However, since the pressing ribs 142 are separately in contact with the O-ring 17 at points, the deformed portion of the O-ring 17 is accommodated within the groove 142a. A sufficiently waterproof performance can, therefore, be secured even when the O-ring 17 is deformed. The prevention of torsion of the O-ring 17 prevents poor fitting of the lid 14 when the lid 14 is closed. Poor fitting of the lid 14 is caused by the O-ring 17 returning to its original shape after being twisted. This ensures an excellent appearance.

A connector 18 and the like is disposed inside the opening 131 for connecting to, e.g., an external device not shown. The mobile phone is connected to the external device with the lid 14 open. The lid 14 is closed, when the mobile phone and the external device are disconnected, keeping the phone waterproof.

In the foregoing embodiment, the pressing ribs 142b for pressing the O-ring 17 are formed only in the portion of the lid 14 at which the opening or closing movement is large. However, the pressing ribs 142b may be disposed separately in a wider area along the groove 142a. The pressing ribs 142b may be disposed, for example, along the entire circumference of the groove 142.

Each of the pairs of pressing ribs project towards each other from the opposite walls defining the groove 142a. However, the pressing ribs need not be formed in pairs on both the walls, as long as they are capable of preventing entry of water.

The preferred embodiment adopts a structure in which the O-ring is pressed in the direction of groove width by the plurality of pressing ribs disposed separately. This prevents the O-ring from being twisted even if it is subjected to a sideways force during opening or closing of the lid. Accordingly, waterproof performance is secured despite repeated opening or closing of the lid, while poor fitting of the lid due to torsion of the O-ring is prevented, and hence a satisfactory appearance is ensured.

In the preferred embodiment, the pressing ribs are separately disposed, thus leaving sufficient space in the groove for the O-ring to be pressed and deformed when the lid is closed. Therefore, the mobile device is free from waterproof performance degradation, which may occur, for example, in the case where the width of the groove with the O-ring fitted therein is narrowed, with the result that there is no more space to accommodate the O-ring if it is deformed.

In the preferred embodiment, the plurality of pressing ribs is separately disposed along the groove such that each of the pairs of pressing ribs project toward each other from the opposite walls defining the groove.

If the O-ring is pressed from only one direction of the groove, the O-ring may be curved and unnecessary pressure may be applied thereto. However, in the preferred embodiment, pressing the O-ring with the pairs of pressing ribs from both sides of the groove prevent curving of the O-ring, thus maintaining the improved waterproof performance.

The device disclosed in the preferred embodiment prevents torsion of the O-ring despite repeated opening or closing of the lid and maintains secure waterproof performance and a satisfactory appearance.

All examples and conditional language recited herein for pedagogical purposes to aid the reader in understanding the principles of the invention and the concepts contributed by the inventor to furthering the art, and are to be construed as being without limitation to such specifically recited examples and conditions, nor does the organization of such example in the specification relate to a showing of the superiority and inferiority of the invention. Although the embodiments of the present inventions have been described in detail, it should be understood that the various changes, substitutions, and alterations could be made hereto without departing from the spirit and scope and scope of the invention.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A mobile device comprising:
a housing in which an opening is defined; and
a lid freely uncovering or covering the opening, the lid having a body plate defining part of an outer shape of the mobile device, a fitting projection projecting from an opening side face of the body plate and fitting into the opening, and a groove formed all the way along a periphery in which a waterproof O-ring is disposed,
wherein the O-ring prevents entry of water into the opening by being fitted in the groove so as to be in contact with an internal wall face of the opening, and
wherein the projection has a plurality of pressing ribs that are separately disposed along the groove so as to project in the inward direction of the groove at least in a portion opposite a rotation shaft and so as to narrow the groove.

2. The mobile device according to claim 1, wherein the plurality of pressing ribs are disposed such that a plurality of pairs of pressing ribs projecting toward each other from opposite walls defining the groove are separately disposed along the groove.

3. The mobile device according to claim 1, wherein the fitting projection of the lid has the rotation shaft projection in a place corresponding to the one edge of the opening, and also has a locking projection, the rotation shaft projection being such that the rotation shaft projection enters inside the one edge of the housing, and is locked by the housing so as to be freely rotated, thereby serving as the rotation shaft, and the locking projection being such that the locking projection enters and locks inside another edge of the opening, opposite the one edge, thereby keeping the lid in a closed position.

4. The mobile device according to claim 1, wherein the opening is a vertical oval shape, and the fitting projection projects in the shape of a vertical oval so as to fit into the opening, the lid rotates around the rotation shaft formed at one end of the long axis of the fitting projection and extending parallel to a short axis of the fitting projection so as to open and close, and the pressing ribs are formed at least at the other end of the long axis.

5. The mobile device according to claim 1, wherein a connector for electrically connecting with an external device is disposed in the housing so as to be exposed from the opening.

6. The mobile device according to claim 1, wherein the mobile device is a mobile phone that has a radio communication function.

7. The mobile device according to claim 2, wherein the fitting projection of the lid has the rotation shaft projection in a place corresponding to the one edge of the opening, and also has a locking projection, the rotation shaft projection being such that the rotation shaft projection enters inside the one edge of the housing, and is locked by the housing so as to be freely rotated, thereby serving as the rotation shaft, and the locking projection being such that the locking projection enters and locks inside another edge of the opening, opposite the one edge, thereby keeping the lid in a closed position.

8. A mobile device comprising:
a housing in which an opening is defined; and
a lid freely uncovering or covering the opening, the lid having a body plate defining part of an outer shape of the mobile device, a fitting projection projecting from an opening side face of the body plate and fitting into the opening, and a groove formed all the way along a periphery of the lid;
a waterproof O-ring disposed in the groove, the O-ring preventing entry of water into the opening by being fitted in the groove so as to be in contact with an internal wall face of the opening, and
a plurality of pressing ribs that are separately disposed on the projection along the groove so as to project in the inward direction of the groove at least in a portion opposite a rotation shaft and so as to narrow the groove.

9. A method of sealing an opening in a mobile device, comprising:
defining the opening in a housing;
uncovering or covering the opening freely with a lid;
providing a body plate for the lid;
defining part of an outer shape of the mobile device with the body plate;
projecting a fitting projection from an opening side face of the body plate;
fitting a groove formed all the way along a periphery of the lid into the opening;
disposing a waterproof O-ring in the groove so as to be in contact with an internal wall face of the opening;
preventing entry of water into the opening with the O-ring fitted in the groove, and
disposing a plurality of pressing ribs separately on the projection along the groove so as to project in the inward direction of the groove at least in a portion opposite a rotation shaft and so as to narrow the groove.
